(19) United States
(12) Patent Application Publication
(10) Pub. No.: US 2005/0110464 A1
(43) Pub. Date: May 26, 2005

(54) Fuel cell voltage monitoring system

(76) Inventor: Howard S. Baker, Randolph, MA (US)

Correspondence Address: CHEVRON TEXACO CORPORATION, P.O. BOX 6006, SAN RAMON, CA, 94583-0806, US

(21) Appl. No.: 10/723,105

(22) Filed: Nov. 25, 2003

(51) Int. Cl. H02J 7/00

(52) U.S. Cl. 320/134

(57) ABSTRACT

The invention includes, in one embodiment, a system for monitoring a plurality of cell voltages of an electrochemical device for a plurality of cells connected in series, the system including: a plurality of connecting pins for removable connection across the plurality of cells; a plurality of differential amplifiers, each differential amplifier having a plurality of laser wafer trimmed resistors providing matching, so that common mode signals are rejected, while differential input signals are amplified, each differential amplifier having two inputs and one output, where the inputs are each connected to the plurality of connecting pins; a switching network having a plurality of inputs and one output, the inputs of the switching network connected to the outputs of the differential amplifiers; not more than one analog to digital converter per 16 cells having an input connected to the output of the switching network and adapted to provide digital values indicative of the voltages measured by the plurality of differential amplifiers; and a power supply to supply regulated power to at least one electrical circuit consisting of the differential amplifiers, switching network, and mixtures thereof, where the power supply derives its power from the plurality of cells.

### COPYRIGHT NOTICE AND AUTHORIZATION

This patent document contains material which is subject to copyright protection.

© Copyright 2003. Analytic Energy Systems, LLC. All rights reserved.

With respect to this material which is subject to copyright protection, the owner, Analytic Energy Systems, LLC, has no objection in the facsimile reproduction by any one of the patent disclosure, as it appears in the Patent and Trademark Office patent files or records of any country, but otherwise reserves all rights whatsoever.

### FIELD OF THE INVENTION

The invention relates to measuring cell voltages of a fuel cell or battery cell stack.

### BACKGROUND OF THE INVENTION

A fuel cell is an electrochemical device that converts chemical energy produced by a reaction directly into electrical energy. For example, one type of fuel cell includes a proton exchange membrane (PEM), a membrane that may permit only protons to pass between an anode and a cathode of the fuel cell. At the anode, diatomic hydrogen (a fuel) is oxidized to produce hydrogen protons that pass through the PEM. The electrons produced by this oxidation travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and
O₂+4H⁺+4e⁻→2H₂O at the cathode of the cell.

See, for example, U.S. Pat. No. 5,272,017. Because a single fuel cell typically produces a relatively small voltage (around 1 volt, for example), several fuel cells may be formed out of an arrangement called a fuel cell stack to produce a higher voltage. The fuel cell stack may include plates (graphite composite or metal plates, as examples) that are stacked one on top of the other, and each plate may be associated with more than one fuel cell of the stack. The plates may be made from a graphite composite material and include various channels and orifices to, as examples, route the reactants and products through the fuel cell stack. Several PEMs (each one being associated with a particular fuel cell) may be dispersed throughout the stack between the anodes and cathodes of the different fuel cells.

The health of a fuel cell stack may be determined by monitoring the individual different terminal voltages (herein called cell voltages) of the fuel cells. In this manner, a particular cell voltage may vary under load conditions and cell health over a range from −1 volt to +1 volt. The fuel cell stack typically may include a large number of fuel cells, and thus, common mode voltages (voltages with respect to a common voltage (ground)) of the terminals of the fuel cells 16 may be quite large (i.e., some of the voltages of the terminals may be near 100 volts, for example). Unfortunately, semiconductor devices that may be used to measure the cell voltages typically are incapable of receiving high common mode voltages (voltages over approximately 18 volts, for example).

For example, referring to FIG. 1, in a fuel cell system 1, a fuel cell voltage monitoring system 5 may be used to measure the differential voltages across fuel cells 10 (fuel cells 10₁ 10₂ . . . 10ₙ, as examples) of a fuel cell stack 11. The stack 11 forms an overall stack voltage called V_{STACK}. Because the fuel cells 10₁ to 10ₙ are serially coupled together, the common mode voltage of a particular cell 10 becomes progressively greater the farther the cell 10 is away from the ground connection. For example, the cell voltages of the terminals 15 and 16 may have relatively low common mode voltages, as the voltages of the terminals 15 and 16 are formed from one fuel cell 10₁ and two fuel cells 10₁ and 10₂, respectively. However, farther from the ground connection, a cell terminal 95 has a much higher common mode voltage.

Various parameters have to be monitored to ensure proper fuel cell stack operation. One of these parameters is the voltage across each fuel cell in the fuel cell stack hereinafter referred to as cell voltage. Therefore, differential voltage measurement is required at the two terminals (i.e., anode and cathode) of each fuel cell in the fuel cell stack. A particular cell voltage may vary under load conditions and cell health over a range from −1 volt to +1 volt (Note: a battery cell voltage range may be much larger, e.g., ±300 volts).

However, since fuel cells are connected in series, and typically in large number, the common mode voltages (voltages with respect to a common voltage (i.e., ground)) at some terminals will be too high for most currently available semiconductor measuring device to directly measure. For example, for a fuel cell stack consisting of 100 cells with each cell voltage at 0.95 volts, the actual voltage on the negative terminal (cathode) of the top cell will be 94.05 volts (i.e., 0.95*100−0.95). As discussed above, the voltage exceeds the maximum allowable input voltage of differential amplifiers commonly used for measuring voltage.

Various efforts have been made to overcome this problem. One method for monitoring high cell voltages is disclosed by U.S. Pat. No. 5,914,606 which teaches monitoring battery cell voltage with the aid of voltage dividers. The voltage dividers are connected to measurement points on a stack of cells. The voltage dividers reduce the voltage at each measurement point so that each voltage is low enough to be an input to a conventional differential amplifier.

When the voltage dividers are “closely matched”, the output of the differential amplifier is directly proportional to the differential voltage between the pair of points at which the voltage dividers are connected. Hence the differential voltage between those two points can be determined. By selecting the “ratio” of each voltage divider, the system can be used to measure differential voltages in the presence of different common-mode voltages.

In this manner, the voltage monitoring circuit may use the circuitry to indicate a scaled down version of a particular cell voltage and then derive an indication of the actual cell voltage by upscaling the scaled down value by the appropriate amount. For example, the circuitry may scale down the voltages by a factor of 10. Therefore, for this example, the circuitry may receive a voltage of 100 volts and provide a corresponding voltage of 10 volts to a semiconductor that is used to measure the cell voltage, for example. The '606 patent, however, used discrete components, i.e., discrete voltage dividers, a switch between a single differential amplifier and multiple cells, and a non-integral power supply. These elements result in a high-production cost voltage monitor that is not easily packaged and installed and various cell stack configurations.

Another system for monitoring high voltages was disclosed in U.S. Pat. No. 5,712,568. The '568 patent teaches the use of an optical isolation technique to separate the voltage measurement process. Unfortunately, this method is both costly and difficult to implement. U.S. Pat. No. 6,140,820 also disclosed a voltage monitoring system that used isolation methods incorporating a multiplexer and differential inputs. However, this voltage monitoring system also suffers from impedance mismatch and reduced accuracy.

The above methods do not provide a simple and cost-efficient system for monitoring cell voltage. As fuel cell stacks become larger and more complex, there is an increasing need for simple and accurate cell voltage measurement systems. It would be desirable to have a system for monitoring fuel cell stack voltages as high as ±270 volts that is accurate, inexpensive, and avoids the shortcomings of known systems. This invention provides such a solution.

### SUMMARY OF THE INVENTION

The invention includes, in one embodiment, a system for monitoring a plurality of cell voltages of an electrochemical device for a plurality of cells connected in series, the system including: a plurality of connecting pins for removable connection across the plurality of cells; a plurality of differential amplifiers, each differential amplifier having a plurality of laser wafer trimmed resistors providing matching, so that common mode signals are rejected, while differential input signals are amplified, each differential amplifier having two inputs and one output, where the inputs are each connected to the plurality of connecting pins; a switching network having a plurality of inputs and one output, the inputs of the switching network connected to the outputs of the differential amplifiers; not more than one analog to digital converter per 16 cells having an input connected to the output of the switching network and adapted to provide digital values indicative of the voltages measured by the plurality of differential amplifiers; and a power supply to supply regulated power to at least one electrical circuit consisting of the differential amplifiers, switching network, and mixtures thereof, where the power supply derives its power from the plurality of cells.

In an alternate embodiment, the invention includes a system for monitoring a plurality of cell voltages of a fuel cell stack or battery bank having a plurality of cells connected in series, the system including: a plurality of connecting pins for removable connection across the plurality of cells, the plurality of cells having a cumulative maximum voltage of at least about 225 volts; a plurality of differential amplifiers, each differential amplifier having a plurality of laser wafer trimmed resistors providing matching, so that common mode signals are rejected, while differential input signals are amplified, where the differential amplifiers each produce an output such that the voltage of a cell being measured is determined with an error of about 0.02 percent or less, each differential amplifier having two inputs and one output, where the inputs are each connected to the plurality of connecting pins, a switching network having a plurality of inputs and one output, the inputs of the switching network connected to the outputs of the differential amplifiers; not more than one analog to digital converter per 16 cells having an input connected to the output of the switching network and adapted to provide digital values indicative of the voltages measured by the plurality of differential amplifiers; a power supply to supply regulated power to at least one electrical circuit consisting of the voltage dividers, differential amplifiers, switching network, and mixtures thereof, where the power supply derives its power from the plurality of cells; and a single housing, where each system component is housed therein.

In an alternate embodiment, the invention includes, a system for monitoring a plurality of cell voltages of a fuel cell stack having a plurality of cells connected in series, the system including: a plurality of connecting pins for removable connection across the plurality of cells, the plurality of cells having a cumulative maximum voltage of at least about 250 volts; a plurality of differential amplifiers, each differential amplifier having a plurality of laser wafer trimmed resistors providing matching, so that common mode signals are rejected, while differential input signals are amplified, where each differential amplifier is adapted to reject a common-mode voltage of at least ±270 volts, where the differential amplifiers each produce an output such that the voltage of a cell being measured is determined with a gain nonlinearity error of about 3 parts per million or less, each differential amplifier having two inputs and one output, where the inputs are each connected to the plurality of connecting pins; a switching network having a plurality of inputs and one output, the inputs of the switching network connected to the outputs of the differential amplifiers; not more than one analog to digital converter per 16 cells having an input connected to the output of the switching network and adapted to provide digital values indicative of the voltages measured by the plurality of differential amplifiers; a power supply to supply regulated power to at least one electrical circuit consisting of the voltage dividers, differential amplifiers, switching network, and mixtures thereof, where the power supply derives its power from the plurality of cells; and-a single housing, where each system component is housed therein.

In an alternate embodiment, the invention includes a method for monitoring a plurality of cell voltages of an electrochemical device for a plurality of cells connected in series and having output terminals, the method including the steps of: connecting the voltages from the terminals of each cell to the inputs of a differential amplifier, each differential amplifier having a plurality of laser wafer trimmed resistors providing matching, so that common mode signals are rejected, while differential input signals are amplified, each differential amplifier having two inputs and one output; rejecting the common-mode voltage from the voltages at the terminal of each cell, in the differential amplifier, to give the voltage differential between the two terminals; converting the voltage differential from analog to digital values; and powering the differential amplifier with a power supply to supply regulated power, where the power supply derives its power from the plurality of cells.

### BRIEF DESCRIPTION OF THE DRAWINGS

FIG. 1 is a schematic diagram of a fuel cell voltage monitoring system of the prior art.

FIG. 2 is a schematic diagram of a fuel cell voltage monitoring system according to an embodiment of the invention.

FIG. 3 is a more detailed schematic diagram of a portion of the fuel cell voltage monitoring system of FIG. 2 according to an embodiment of the invention.

FIG. 4 is a schematic diagram of a fuel cell voltage monitoring system having multiple modules according to an embodiment of the invention.

### DETAILED DESCRIPTION OF PREFERRED EMBODIMENTS

The system consists, in one embodiment, of the following components: Spring Probes or connecting pins, laser-wafer trimmed resistive voltage dividers, differential amplifiers, electronic switches, analog to digital converter, power supply, and computer/controller. Optionally, the analog to digital converter and computer/controller are separate components from the inventions but are used in conjunction with the invention in a preferred mode of deployment. Optionally, the laser wafer-trimmed resistors are integral with, or with the housing of, the differential amplifiers.

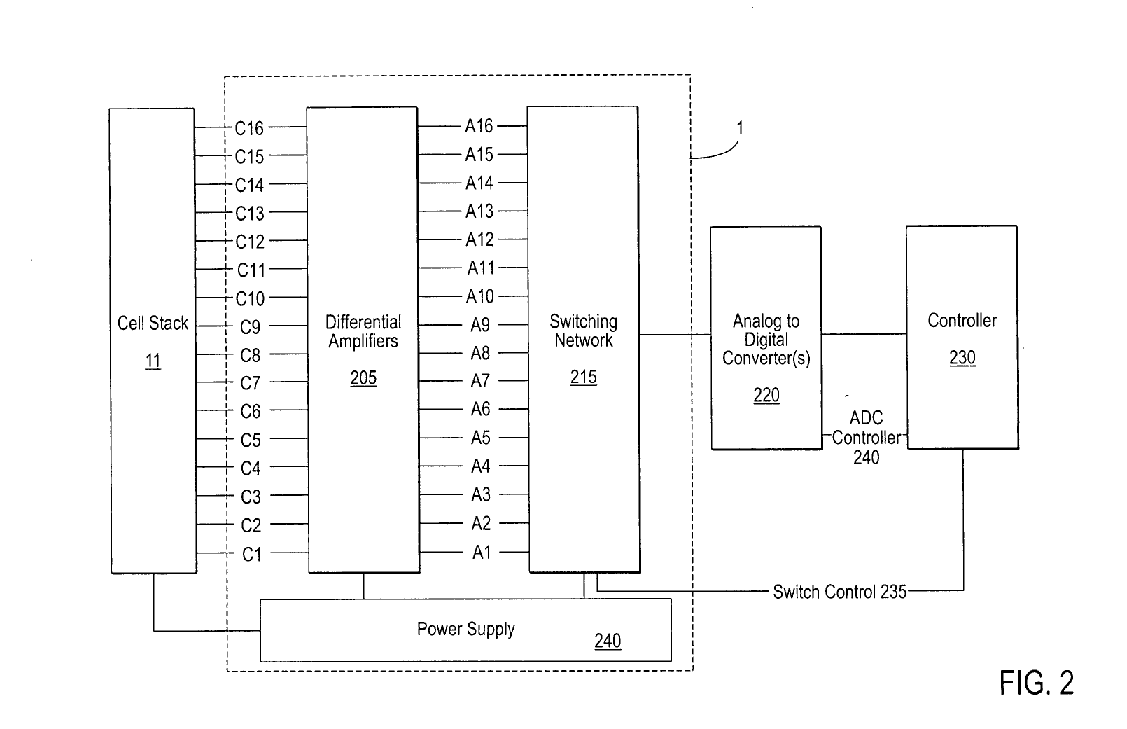

The invention is applicable for monitoring both fuel cell stack or battery cell stack voltages. In the following description, the reference to fuel cells will generally be understood to be equally applicable to battery cells, with exceptions such as fuel cell voltages having lower maximum voltages than battery cell voltages. Referring to FIG. 2, an embodiment 1 of a cell voltage monitoring circuit in accordance with the invention includes a plurality of differential amplifiers 205 coupled to a fuel cell stack 11 for monitoring cell voltages of the fuel cell stack 11. The plurality of differential amplifiers 205 are used wherein each differential amplifier has a high common-mode rejection ratio. Each differential amplifier preferably is also highly linear. Each amplifier may have a gain of substantially unity.

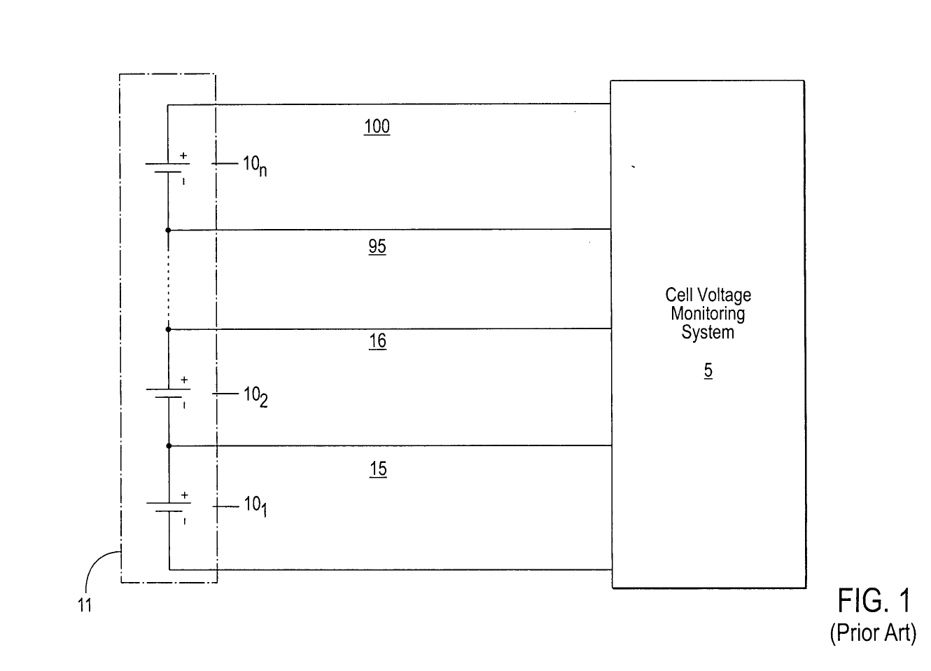

Each amplifier should also be able to reject as high a voltage as possible at each input, but at least sufficient to reject the common mode voltage for the cell stack in question, preferably at least 270 volts. However, the input differential is limited by the power supply voltage as is commonly known in the art. Accordingly, the input differential may be limited to a range of ±18 volts. The plurality of differential amplifiers 205 used in the fuel cell voltage monitoring system 1 may be chosen from any commercially available differential amplifier having a high common-mode rejection ratio. These differential amplifiers can function with a common-mode voltage of up to 270 volts and can therefore be connected directly to the cathode and anode of a fuel cell from the fuel cell stack 11 as shown in FIGS. 1 and 2.

Coupling leads C₁ through C₁₆ provide the coupling between the 2 inputs of each differential amplifier and the anode and cathode of each cell as shown in more detail in FIG. 1. The invention is not limited to a system with the 16 couplings, and thus 16 cells, shown in this embodiment. The invention includes larger cell stacks such as 256 cells, 512 cells, or 1024 cells or other numbers as shall be possible with future cell technology. In one embodiment, the cell stack being monitored by the invention has a maximum stack voltage of ±300 volts.

Preferably, the differential amplifiers produce voltage output for the cell being measured of less than about 0.02 percent error and/or a gain nonlinearity error of not more than about 3 parts per million. The output of each differential amplifier, from the plurality of differential amplifiers 205, is then connected to the inputs A₁ through A₁₆ of the switching network 215. As mentioned above, the invention is not limited to the 16 coupling leads shown in this embodiment, but instead the number would correspond to the number of differential amplifiers which in turn corresponds to the number of cells in the cell stack 11.

Preferably, the switching network 215 may be a multiplexer or the like. The switching network 215, optionally, only allows the differential voltage measured at two points on the fuel cell stack 11 to be accessed at any one time. In other embodiments, there are multiple switches and/or the switch permits monitoring of more than one cell at one time. The cell voltages may also be monitored at a high speed so that measuring only one cell voltage at a time is acceptable. The differential voltage measured at the two terminals on the fuel cell stack 11 are then sent from the switching network 215 to the Analog-to-Digital Converters (“ADCs”) 220.

The ADCs 220 converts the measured analog voltages to digital values. In practice, the ADC 220 may be a 16-bit ADC. Alternatively, an ADC with more bits may be used to obtain more accurate digital values. Typical ADCs commercially available presently have 16 channels. Thus, in a preferred embodiment there is not more than one ADC for each 16 differential amplifiers. After the analog to digital conversion, the digital values are sent to the controller 230.

The controller 230 controls the function of the fuel cell voltage monitoring system 11. In particular, the controller 230 controls the operation of the switching network 215 via a switching network control line 235 and the ADCs 220 via an ADC control signal 240. The controller 230 controls the switching network 215 to selectively receive the digital values for the cell voltage measured at the two terminals of a specific fuel cell in the fuel cell stack 11. Preferably, the controller 230 directs, via switch control line 235, the switching network 215 to access the voltage measured across each fuel cell in the fuel cell stack 11 in sequential order and reads the corresponding digital values from the ADCs 220.

Alternatively, the measured voltage across any fuel cell can be accessed at any time by appropriately programming the controller 230. The controller is preferably a microprocessor but may also be another control device such as a PLC or the like.

The controller 230 can also include a calculating means for converting the digital values read from the ADCs 220 into a measured cell voltage. Optionally, the calculating means is a separate component from the controller or is incorporated into another component. Optionally, the controller 230 is further connected to a computer, e.g., personal computer (not shown), via any known or future developed input-output format, e.g., serial port, parallel port, IEEE 1394 port, USB port, USB 2.0 port, or the like which can be used to provide enhanced data processing to monitor fuel cell performance. Also, the controller, optionally, includes a microprocessor, and/or is a stored-memory computer, i.e., the control functions are governed by a software application which is loaded in memory and processed on a general purpose microprocessor.

The cell voltages allow a user to assess the overall condition of an individual fuel cell. The cell voltages can be used to determine if there is water accumulation in a cell, or if gases are mixing, etc. How often cell voltages are measured is also important. Cell voltage measurement must be sufficiently fast to report brief, transient conditions on the cells. It is preferred to perform a measurement every 10 ms on every cell. The controller 230 may then determine the actual cell voltage by up-scaling the end product by the differential gain (i.e., the ideal scaling ratio) that is introduced by the laser wafer trimmed resistors.

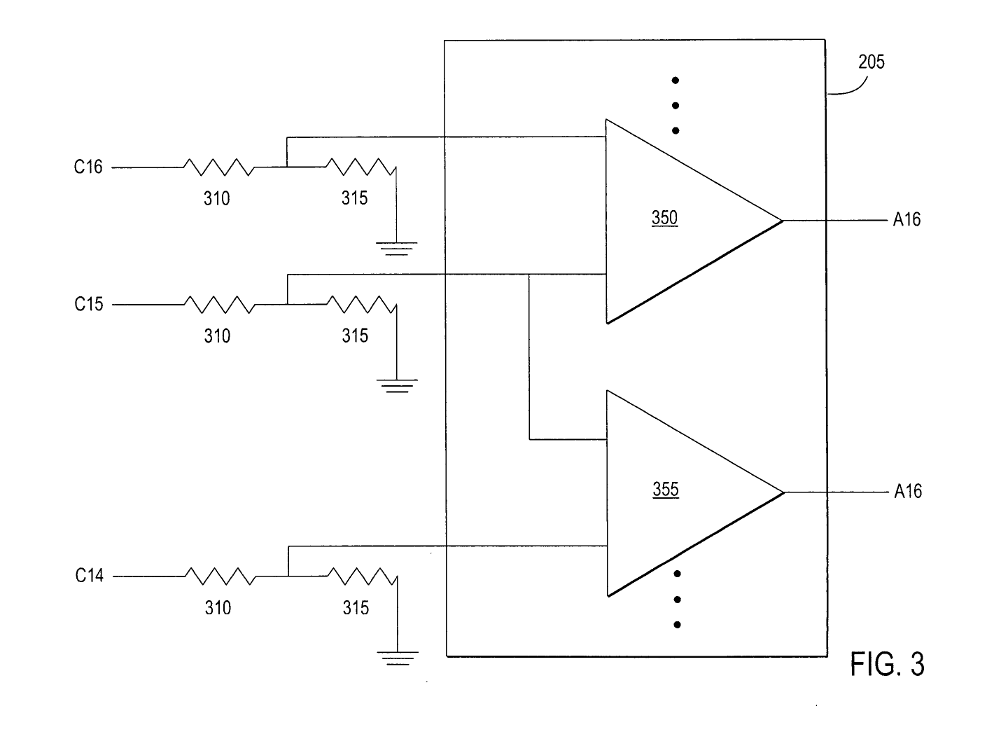

FIG. 3, depicts in greater detail, one embodiment of the differential amplifiers 205, shown in FIG. 2, and optionally integral laser-wafer trimmed resistors 310 and 315. By of example, couplings C₁₅ and C₁₆ to a single cell of the cell stack 1 (shown in FIG. 1) are connected via laser-wafer trimmed resistors 310 and 315. The resistance of laser-wafer trimmed resistors 310 and 315 are selected so as to obtain a sufficient scaling down of the voltage, including common-mode voltages, across the coupled cell. For example, the voltage may be scaled down to less than ±18 volts as required for existing differential amplifiers.

As shown in FIG. 3, coupling C₁₅ passes through laser-wafer trimmed resistors 310 and 315 and then is split to couple with 2 differential amplifiers 350 and 355. This is because in a cell stack the cathode of one cell is coupled to the anode of the connecting cell. Thus, except for the initial an terminal cells in the stack, the each cell coupling will connect to one input each of 2 differential amplifiers. The outputs A₁₆ and A₁₅ of differential amplifiers 350 and 355 are passed via a switching network (not shown, see FIG. 2) to ADCs (not shown, see FIG. 2).

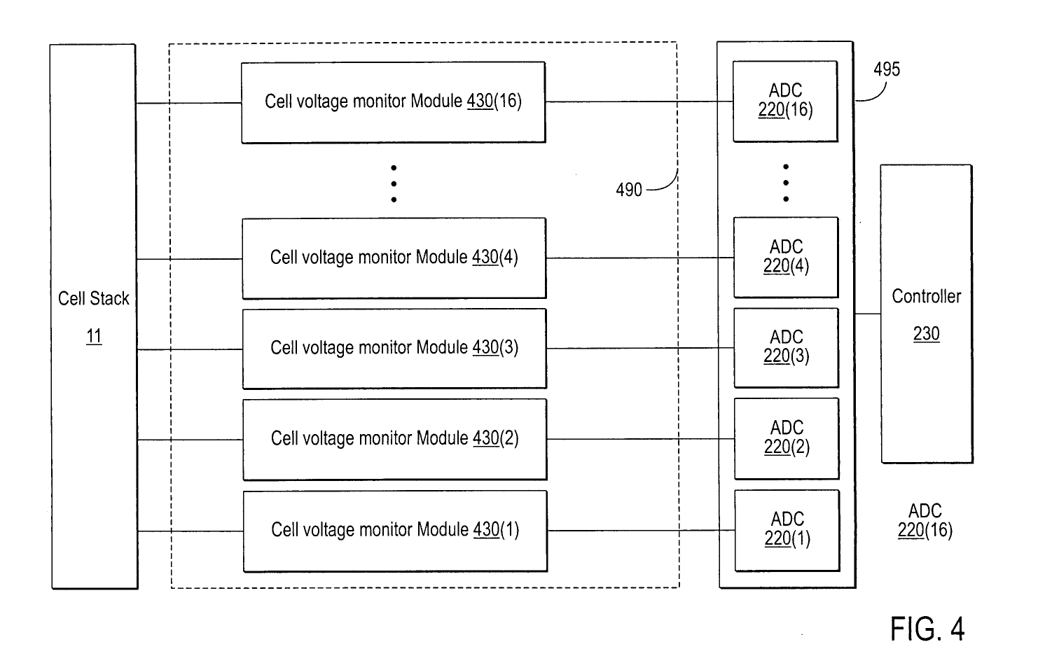

FIG. 4 depicts an alternate embodiment of the invention whereby a plurality of cell voltage monitor modules 430 are assembled to permit monitoring of a variety of size cell stacks. Cell voltage monitor modules 430(1) through 430(16) are depicted where if each module contains 16 differential amplifiers and associated voltage-divider circuits, would permit voltage monitoring of all cells in a 256 cell stack. The invention is not limited to this number and any variation, e.g., 5 or 100 modules, are within the scope of the invention. Voltage monitor modules 430 are connected via a switching network (not shown is this Figure, see FIG. 3) to ADCs 220. The ADCs are coupled to controller 230.

The cell voltage monitoring system is preferably contained in a single housing. This facilitates easy installation and allows for compact size and low-cost production. Multiple cell voltage monitoring system modules (see FIG. 4, element 430 and FIG. 2, element 1) may be installed separately on a cell stack so that some or all of the cells are monitored, or the multiple cell voltage monitoring system may be further contained in a single housing (see FIG. 4, element 490) specific to the cell stack to be monitored.

Several other features are optionally part or used in conjunction with the voltage monitoring system of the invention, the controller 230 may include a program that is stored in a non-volatile memory of a controller, such as an EEPROM or a flash memory, as just a few examples. In this manner, the program, when executed by the controller 230, may cause the controller 230 to perform the functions described above. The controller 230 may also include the ADCs 220 as integral components rather than using discrete ADCs 220 to convert the analog output signal from the differential amplifiers 205.

In some embodiments, the memory may be an internal memory of the controller 230, and in some embodiments, the memory 230 may be formed from external memory chips that are coupled to the controller. The voltage monitoring system 1 may also include a power supply 240 (FIG. 2) that furnishes power derived from cell stack 11 to differential amplifiers 205 and other components integral to the voltage monitoring system 1 such as switching network 215 (FIG. 2) and ADCs 220. The power supply 240 may receive power from power conditioning circuitry (not shown) that is associated with the fuel cell stack 11. Alternatively, a computer may store a program that may cause a microprocessor of the computer to, when executing the program, perform the functions described above. Copies of the programs may be stored on storage devices, such as CD-ROMs and floppy disk drives, as just a few examples.

The invention includes the method of using the above-described cell voltage monitoring system to monitor the cell voltages of individual cells in a cell stack. This includes the method of installing such system, passing the voltages from each cell to a differential amplifier after scale-down by a voltage divider network having laser-wafer trimmed resistors, outputting a voltage differential for each cell, passing the output via a switch to an ADC, converting the output to a digital value, and passing the digital value to a controller, computer, or calculating means for conversion into an actual voltage for the cell. The invention also includes any use of such actual voltage information for the maintenance and operation of a cell stack, e.g., bypassing a cell or shutting down a cell stack if actual voltage information indicates abnormal cell voltages.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

1. A system for monitoring a plurality of cell voltages of an electrochemical device for a plurality of cells connected in series, the system comprising:
(a) a plurality of connecting pins for removable connection across the plurality of cells;
(b) a plurality of differential amplifiers, each differential amplifier having a plurality of laser wafer trimmed resistors providing matching, so that common mode signals are rejected, while differential input signals are amplified, each differential amplifier having two inputs and one output, wherein the inputs are each connected to the plurality of connecting pins;
(c) a switching network having a plurality of inputs and one output, the inputs of the switching network connected to the outputs of the differential amplifiers;
(d) not more than one analog to digital converter per 16 cells having an input connected to the output of the switching network and adapted to provide digital values indicative of the voltages measured by the plurality of differential amplifiers; and
(e) a power supply to supply regulated power to at least one electrical circuit consisting of the differential amplifiers, switching network, and mixtures thereof, wherein the power supply derives its power from the plurality of cells.

2. The system of claim 1, further comprising a controller connected to the switching network and the analog to digital converter to control the operation of the switching network and the analog to digital converter, wherein the controller is further adapted to receive the digital values from the output of the analog to digital converter.

3. The system of claim 1, wherein the plurality of cells comprise fuel cells.

4. The system of claim 1, wherein the plurality of cells comprise battery cells.

5. The system of claim 1, wherein said plurality of cells have a cumulative maximum voltage of about 270 volts.

6. The system of claim 4, wherein each cell has a maximum voltage of about ±300 volts.

7. The system of claim 1, wherein said differential amplifiers each produce an output such that the voltage of a cell being measured is determined with an error of about 0.02 percent or less.

8. The system of claim 1, wherein said differential amplifiers each produce an output such that the voltage of a cell being measured is determined with a gain nonlinearity error of about 3 parts per million or less.

9. The system of claim 1, further comprising a single housing, wherein each system component is housed therein.

10. The system of claim 9, wherein each single housing and system component housed therein comprises a module for monitoring the voltage of least 16 cells, and further comprising at least 16 of the modules configured to monitor cell voltages of least 256 cells of a single cell stack.

11. The system of claim 1, wherein the system further includes a calculating means, connected to the output of one of the analog to digital converters and the controller, to calculate the at least one cell voltage based on the digital values.

12. The system of claim 1, wherein each differential amplifier is adapted to reject a common-mode voltage of at least ±270 volts.

13. The system as claimed in claim 1, wherein the controller comprises a microprocessor.

14. The system as claimed of claim 1, wherein the system further comprises a computer and the controller is connected to the computer.

15. A system for monitoring a plurality of cell voltages of a fuel cell stack or battery bank having a plurality of cells connected in series, the system comprising:
(a) a plurality of connecting pins for removable connection across the plurality of cells, the plurality of cells having a cumulative maximum voltage of at least about 225 volts;
(b) a plurality of differential amplifiers, each differential amplifier having a plurality of laser wafer trimmed resistors providing matching, so that common mode signals are rejected, while differential input signals are amplified, wherein said differential amplifiers each produce an output such that the voltage of a cell being measured is determined with an error of about 0.02 percent or less, each differential amplifier having two inputs and one output, wherein the inputs are each connected to the plurality of connecting pins,
(c) a switching network having a plurality of inputs and one output, the inputs of the switching network connected to the outputs of the differential amplifiers;
(d) not more than one analog to digital converter per 16 cells having an input connected to the output of the switching network and adapted to provide digital values indicative of the voltages measured by the plurality of differential amplifiers;
(e) a power supply to supply regulated power to at least one electrical circuit consisting of the voltage dividers, differential amplifiers, switching network, and mixtures thereof, wherein the power supply derives its power from the plurality of cells; and
(f) a single housing, wherein each system component is housed therein.

16. The system of claim 15, wherein each single housing and system component housed therein comprises a module for monitoring the voltage of least 16 cells, and further comprising at least 16 of the modules configured to monitor cell voltages of least 256 cells of a single cell stack.

17. The system of claim 15, further comprising a controller connected to the switching network and the analog to digital converter to control the operation of the switching network and the analog to digital converter, wherein the controller is further adapted to receive the digital values from the output of the analog to digital converter.

18. The system of claim 15, wherein the plurality of cells comprise fuel cells.

19. The system of claim 15, wherein the plurality of cells comprise battery cells.

20. The system of claim 15, wherein said plurality of cells have a cumulative maximum voltage of not more than about 270 volts.

21. The system of claim 19, wherein each cell has a maximum voltage of about ±300 volts.

22. The system of claim 15, wherein said differential amplifiers each produce an output such that the voltage of a cell being measured is determined with a gain nonlinearity error of about 3 parts per million or less.

23. The system of claim 15, wherein the system further includes a calculating means, connected to the output of one of the analog to digital converters and the controller, to calculate the at least one cell voltage based on the digital values.

24. The system of claim 15, wherein each differential amplifier is adapted to reject a common-mode voltage of at least ±270 volts.

25. The system as claimed in claim 15, wherein the controller comprises a microprocessor.

26. A system for monitoring a plurality of cell voltages of a fuel cell stack having a plurality of cells connected in series, the system comprising:
(a) a plurality of connecting pins for removable connection across the plurality of cells, the plurality of cells having a cumulative maximum voltage of at least about 250 volts;
(b) a plurality of differential amplifiers, each differential amplifier having a plurality of laser wafer trimmed resistors providing matching, so that common mode signals are rejected, while differential input signals are amplified, wherein each differential amplifier is adapted to reject a common-mode voltage of at least ±270 volts, wherein said differential amplifiers each produce an output such that the voltage of a cell being measured is determined with a gain nonlinearity error of about 3 parts per million or less, each differential amplifier having two inputs and one output, wherein the inputs are each connected to the plurality of connecting pins;
(c) a switching network having a plurality of inputs and one output, the inputs of the switching network connected to the outputs of the differential amplifiers;
(d) not more than one analog to digital converter per 16 cells having an input connected to the output of the switching network and adapted to provide digital values indicative of the voltages measured by the plurality of differential amplifiers;
(e) a power supply to supply regulated power to at least one electrical circuit consisting of the voltage dividers, differential amplifiers, switching network, and mixtures thereof, wherein the power supply derives its power from the plurality of cells; and
(f) a single housing, wherein each system component is housed therein.

27. The system of claim 26, wherein each single housing and system component housed therein comprises a module for monitoring the voltage of least 16 cells, and further comprising at least 16 of the modules configured to monitor cell voltages of least 256 cells of a single cell stack.

28. The system of claim 26, further comprising a controller connected to the switching network and the analog to digital converter to control the operation of the switching network and the analog to digital converter, wherein the controller is further adapted to receive the digital values from the output of the analog to digital converter.

29. The system of claim 26, wherein said plurality of cells have a cumulative maximum voltage of about 270 volts.

30. The system of claim 26, wherein each cell has a maximum voltage of about ±1 volts.

31. The system of claim 26, wherein said differential amplifiers each produce an output such that the voltage of a cell being measured is determined with an error of about 0.02 percent or less.

32. The system of claim 26, wherein the system further includes a calculating means, connected to the output of one of the analog to digital converters and the controller, to calculate the at least one cell voltage based on the digital values.

33. The system as claimed in claim 26, wherein the controller comprises a microprocessor.

34. The system as claimed of claim 26, wherein the system further comprises a computer and the controller is connected to the computer.

35. A method for monitoring a plurality of cell voltages of an electrochemical device for a plurality of cells connected in series and having output terminals, the method comprising the steps of:
(a) connecting the voltages from the terminals of each cell to the inputs of a differential amplifier, each differential amplifier having a plurality of laser wafer trimmed resistors providing matching, so that common mode signals are rejected, while differential input signals are amplified, each differential amplifier having two inputs and one output;
(b) rejecting the common-mode voltage from the voltages at the terminal of each cell, in the differential amplifier, to give the voltage differential between the two terminals;
(c) converting the voltage differential from analog to digital values; and
(d) powering the differential amplifier with a power supply to supply regulated power, wherein the power supply derives its power from the plurality of cells.

36. The method as claimed in claim 35, the plurality of cells having a cumulative maximum voltage of at least about 250 volts.

37. The method as claimed in claim 35, which includes connecting the outputs of the differential amplifiers through a switching network to an analog to digital converter, using the switching network to switch the output of one of the differential amplifiers to the analog to digital converter for analog to digital conversion of the voltage differential at the output of said one differential amplifier.

38. The method claim 35, further comprising connecting the switching network and the analog to digital converter to a controller to control the operation of the switching network and the analog to digital converter, wherein the controller is further adapted to receive the digital values from the output of the analog to digital converter.

39. The method of claim 35, wherein the plurality of cells comprise fuel cells.

40. The method of claim 35, wherein the plurality of cells comprise battery cells.

41. The method of claim 35, wherein said plurality of cells have a cumulative maximum voltage of about 270 volts.

42. The method of claim 35, wherein each cell has a maximum voltage of about ±300 volts.

43. The method of claim 35, wherein said differential amplifiers each produce an output such that the voltage of a cell being measured is determined with an error of about 0.02 percent or less.

44. The method of claim 35, wherein said differential amplifiers each produce an output such that the voltage of a cell being measured is determined with a gain nonlinearity error of about 3 parts per million or less.

45. The method of claim 35, further comprising a single housing, wherein each system component is housed therein.

46. The method of claim 35, wherein the system further includes a calculating means, connected to the output of one of the analog to digital converters and the controller, to calculate the at least one cell voltage based on the digital values.

47. The method of claim 35, wherein each differential amplifier is adapted to reject a common-mode voltage of at least ±270 volts.

48. The method as claimed in claim 35, wherein the controller comprises a microprocessor.

49. The method as claimed of claim 35, wherein the system further comprises a computer and the controller is connected to the computer.
